(19) United States
(12) Patent Application Publication
(10) Pub. No.: US 2023/0354492 A1
(43) Pub. Date: Nov. 2, 2023

(54) LUMINAIRE SYSTEM AND METHOD FOR DETERMINING WATER INGRESS INTO A LUMINAIRE

(71) Applicant: SIGNIFY HOLDING B.V., EINDHOVEN (NL)

(72) Inventors: PETER DEIXLER, ARLINGTON, MA (US); HARRY BROERS, 'S-HERTOGENBOSCH (NL); HUGO JOSÉ KRAJNC, EINDHOVEN (NL); WILLEM DIRK VAN DRIEL, 'S-HERTOGENBOSCH (NL)

(21) Appl. No.: 18/030,118

(22) PCT Filed: Sep. 29, 2021
(86) PCT No.: PCT/EP2021/076847

§ 371 Date: Apr. 4, 2023

Related U.S. Application Data
(60) Provisional application No. 63/087,510, filed on Oct. 5, 2020.

(30) Foreign Application Priority Data
Oct. 16, 2020 (EP) 20202181.2

(51) Int. Cl. H05B 45/50; H05B 47/17; F21V 15/01; F21V 31/03

(52) U.S. Cl. CPC H05B 45/50; H05B 47/17; F21V 15/012; F21V 31/03; F21Y 2115/10

(57) ABSTRACT

The invention relates to a luminaire system (100) comprising a lighting unit (101), a housing (102) containing at least a part of the lighting unit, wherein the lighting unit and the housing are parts of a luminaire, and a sensing means (103) positioned at or within the housing, wherein the sensing means is adapted to sense a functional parameter indicative of a functional characteristic of the luminaire that is influenced by water ingress into at least a part of the luminaire. Further, the luminaire system comprises a water ingress determination unit (104) being adapted to determine water ingress into at least a part of the luminaire based on the sensed functional parameter. Thus, a luminaire system is provided that allows to determine water ingress into a luminaire before the water can damage the luminaire such that the persistence and safety of the luminaire is improved.

### FIELD OF THE INVENTION

The invention relates to a luminaire system, a method and a computer program product for determining water ingress into a lighting unit.

### BACKGROUND OF THE INVENTION

Water ingress in luminaires is an epidemic failure that continues to appear near the top of the yearly incidents. Water ingress often leads to either corrosion, condensation on transparent parts such as windows of the luminaires, or even catastrophic product field failures, both for outdoor and indoor luminaires.

In connected luminaire systems comprising a plurality of luminaires, there is an unmet need to monitor each individual luminaire for possible water condensation and/or water ingress. Therefore, there is a need for low-cost sensor hardware to achieve this water ingress sensing function. There is further a need for a sensing function capable of predicting whether the water ingress only leads to condensation or has even resulted in accumulated water puddles. Water puddles may lead to product failure that might even be safety critical. On the other extreme of severity, condensation usually occurs first on lenses and reflectors and only decreases the luminaire's ability to properly illuminate an environment and/or impacts the aesthetic appearance of the luminaire. Hence, there is a desire to measure the water ingress precisely and easily for each individual luminaire to overcome these problems. US 2017/184659A1 discloses a light fixture including at least one light fixture component. The light fixture can also include at least one sensor that measures at least one parameter associated with the at least one light fixture component. The light fixture can further include a prognostic and health monitoring (PHM) system coupled to the at least one sensor, where the PHM system analyzes at least one measurement, made by the at least one sensor, to identify at least one factor that affects longevity of the at least one light fixture component.

### SUMMARY OF THE INVENTION

It is an object of the present invention to provide a luminaire system, a method and a computer program product allowing for an improved persistence and safety of a luminaire.

In a first aspect, a luminaire system is presented, wherein the system comprises a) a lighting unit being adapted to provide light, b) a housing containing at least a part of the lighting unit, wherein the lighting unit and the housing are parts of a luminaire, c) a sensing means positioned at or within the housing adapted to sense a functional parameter indicative of a functional characteristic of the luminaire that is influenced by water ingress into at least a part of an inner structure of the luminaire, and d) a water ingress determination unit being adapted to determine water ingress into at least a part of the inner structure of the luminaire based on the sensed functional parameter.

Since the water ingress determination unit is adapted to determine water ingress into at least a part of the inner structure of the luminaire based on a sensed functional parameter indicative of a functional characteristic of the luminaire that is influenced by water ingress, the water ingress can be detected indirectly based on the influence of the water within the luminaire. Thus, direct measurements of the water within the luminaire that are constructional challenging can be avoided. Moreover, generally already small amounts of water that are difficult to measure with common water or moisture sensors can have an impact on a functional characteristic of the luminaire, for instance, a pressure within the housing of the luminaire and can hence allow to detect the presence of the water before a “real” damage of the luminaire, for instance, corrosion is expected. This allows to improve the persistence and safety of a luminaire.

The luminaire comprises at least one lighting unit. The lighting unit is adapted to provide light. In particular, the lighting unit is adapted to provide light, wherein the light comprises electromagnetic radiation with a wavelength from a predetermined range of the electromagnetic spectrum. In particular, the light can comprise electromagnetic radiation with different discrete wavelengths or a continuous wavelength range from a predetermined range of the electromagnetic spectrum. Preferably, the lighting unit is adapted to provide at least visible light. Thereby, visible light is defined by the wavelength range for which a human eye is sensitive, i.e. a wavelength can range from 380 nm to 780 nm. The lighting unit can be adapted to provide white light including radiation with wavelengths in a range of several 100 nm of the visible light, wherein the spectrum can be continuous or discrete. However, the lighting unit can also be adapted to provide colored light including radiation with wavelength in a range of several 10 nm of the visible light as, for instance, green light comprising mainly radiation with wavelengths in a range from 500 nm to 550 nm. The lighting unit can also be adapted to provide any other colored light. Additionally or alternatively, the lighting unit can be adapted to provide light comprising electromagnetic radiation with wavelengths for which the human eye is not sensitive. For instance, the provided light can be disinfection light including radiation of a predetermined range of the electromagnetic spectrum including ultraviolet radiation. The provided light can also include radiation of a predetermined range of the electromagnetic spectrum including infrared radiation.

The lighting unit being adapted to provide light can be any light source emitting electromagnetic radiation with a continuous or discrete wavelength spectrum. For instance, the lighting unit can be a light emitting diode (LED). However, the lighting unit can also comprise other light providing devices like a VCSEL, an incandescent lamp, a halogen lamp, a fluorescent lamp, a metal-halide lamp, a gas discharge lamp etc. The lighting unit can also comprise any combination of light sources. In this case, the light provided by the lighting unit is the sum of the provided light of each light source of the lighting unit.

The lighting unit is adapted to be surrounded at least partly by a housing. The housing is adapted to surround at least a part of the lighting unit. In particular, the housing can also be adapted to surround the whole lighting unit. Preferably, the housing is configured such that it can protect at least a part of the lighting unit against outer conditions like weather conditions. Circuits and electronic parts for controlling and operating the lighting unit can be part of the housing and then connected to the lighting unit or can be part of the lighting unit. The housing can then also surround these circuits and electronic parts at least partially.

The housing can be closed or can have openings. The openings can be adapted to allow entering of, for instance, cables or fixtures into the housing to be connected to the housing or the lighting unit. In this case, the openings can be sealed, for instance, by providing an additional cable seal such that the inside of the housing is protected. Preferably, all openings of the housing are sealed such that water ingress into the housing is prevented.

The housing can be made of one material. Thereby, the housing can be made of glass, transparent plastic, acrylic glass or any other transparent material such that the light provided by the lighting unit can be provided outside the housing. The housing can also be composed of a combination of at least two materials. Preferably, the housing is adapted to protect the inner volume of the housing against outer conditions, as for instance, weather conditions, and is adapted to provide light from the inner volume outwards through the housing. The inner volume of the housing can include at least a part of an inner structure of the luminaire. In such a case, the volume of the housing can be divided by the inner structure. Generally, the sensing means is adapted to sense a functional parameter in the housing. Additionally or alternatively, the sensing means can also be adapted to sense a functional parameter in a part of the housing defined by, for instance, the inner structure of the housing.

The lighting unit and the housing can be regarded as forming a luminaire. A luminaire can be positioned within a building or outside. A plurality of luminaires can be arranged to each other such that they perform a task together, for instance, an illumination or guiding task. Generally, one or more luminaires can be provided in any known manner.

The luminaire system, in particular, the luminaire, further comprises at least one sensing means. The sensing means can be positioned at the housing of the luminaire, i.e. in functional contact with the housing of the luminaire. For instance, the sensing means can be attached to an outside of the housing. Alternatively, the sensing means can be positioned within the housing. For instance, the sensing means can be provided somewhere within the volume enclosed by the housing without direct contact to the housing itself.

The sensing means is adapted to sense a functional parameter indicative of a functional characteristic of the luminaire. Generally, a functional characteristic refers to a characteristic of the luminaire that is functionally related to a function of the luminaire, for instance, to the process of providing light. For example, in the process of providing light a temperature and/or a pressure within the housing can be influenced and thus a temperature and/or a pressure within the housing can be regarded as being functionally related to the lighting function of the luminaire. Moreover, the functional parameter that is measured by the sensing means refers to a functional characteristic that is influenced by water ingress into at least a part of an inner structure of the luminaire, wherein an inner structure of the luminaire can be regarded as the volume included by the housing. For example, a temperature or a pressure within the housing can be influenced by water ingress into at least a part of an inner structure of the luminaire and can in this case refer to a functional characteristic and the sensing means can then be adapted to measure a functional parameter that is indicative of the functional characteristic. Moreover, also other characteristics can be utilized as functional characteristics. For example, in some cases also a conductivity and/or a resistance of a part of the luminaire can be influenced by water ingress into at least a part of an inner structure of the luminaire and thus can be regarded as a functional characteristic of the luminaire. In some cases, the sensing means can be adapted to sense as functional parameter directly the functional characteristic. However, in other embodiments the functional parameter is only indicative of the functional characteristic, i.e. has a known functional relation with the functional characteristic.

The luminaire system comprises a water ingress determination unit. The water ingress determination unit is adapted to determine water ingress into at least a part of an inner structure of the luminaire based on the sensed functional parameter. The water ingress determination unit can be realized as hardware or software on general or dedicated computing system. Generally, the water ingress determination unit is adapted to receive a signal from the sensing means being indicative of the sensed functional parameter, for instance, via wired or wireless connection to the sensing means.

In an embodiment, the water ingress determination unit can be integrated to the luminaire. In this case, the water ingress determination unit can be in the housing of the luminaire or outside the housing. However, the water ingress determination unit can also be provided separately from the luminaire but in wired or wireless communication with the sensing means of the luminaire. For instance, the water ingress determination unit can be part of a separate device, e.g. a software running on a user device, like a smart phone, or can be part of an overall control system, controlling more than one sensing means, or controlling a plurality of different sensors, devices, lighting units and/or luminaires.

The water ingress determination unit can be adapted to determine water ingress into at least a part of an inner structure of the luminaire based on the functional parameter sensed by the sensing means. In particular, the water ingress determination unit can be adapted to utilize a functional relation between an amount of water and/or water vapor present in the inner structure of the luminaire and the functional parameter. Such a functional relation can be stored as part of the water ingress determination unit or can be provided to the water ingress determination unit from an external storage. Generally, such a functional relation can be provided as a mathematical relation, a set of rules, a look-up table, etc. A functional relation between a water ingress into the inner structure of the luminaire and at least one functional parameter can be determined, for instance, by experiments or by computational modelling of the luminaire applying known physical laws and knowledge on the construction of the luminaire. For example, a functional relation can be determined by measuring in an experiment at least one functional characteristic, like the temperature or pressure, within the housing of a luminaire in dependence on an amount of water provided to the inner structure of the luminaire. Based on such measurements known statistical analysis tools can be applied in order to determine a functional relation. Moreover, also machine learning techniques can be applied. For example, the measurement results can be provided as training data to a machine learning algorithm like a neural network, a Bayesian network, etc. such that the algorithm is trained to determine the amount of water in a luminaire based on the functional parameter. The utilization of a machine learning algorithm is particularly advantageous when a plurality of functional parameters, in particular, in form of a functional parameter development, i.e. a profile, is provided by the sensing means, since machine learning algorithms allow the evaluation even of complex relationships of different parameters, if trained accordingly.

A result of the determination of the water ingress can then be provided to a user, for instance, in form of a visual or audible output. For example, the lighting unit can be adapted to provide a specific light, like a light of a specific color, when the water ingress is determined to be possible harmful to the luminaire or might decrease a function of the luminaire like the light emission. Additionally or alternatively, the result can also be provided on a display, for instance, of a user interface in communication with at least the water ingress determination unit, as visualization of the determined water content, for instance, by providing a value indicative of the amount of water determined to be present in the inner structure of the luminaire. Additionally or alternatively, a result of the determination of the water ingress can also be visualized indirectly, for instance, by providing a level of a damage expected to originate from the determined water ingress. Moreover, based on the result, additionally or alternatively, a recommendation can be provided to a user, like the recommendation to change the luminaire, to shut down a power supply of the luminaire or to contact service personal, for instance. Alternatively, the luminaire system can be adapted to automatically react to the result of the water ingress determination. For instance, rules can be stored in the luminaire system that control a function of the luminaire based on the result of the water ingress determination, for example, based on the amount of water determined in the inner structure of the luminaire. In one example, the luminaire system can be adapted to control the lighting unit to increase or decrease the intensity of the provided light and/or to control a spectrum provided by the lighting unit based on the determined water ingress. In cases in which it is determined that the amount of water present in the luminaire might have fatal consequences, the luminaire system can be adapted to control the luminaire to be switched off, such that any risk of failure or shorting of circuitry can be avoided.

In an embodiment, the water ingress determination unit is adapted to determine the water ingress into at least a part of an inner structure of the luminaire by comparing a sensed functional parameter with a predetermined baseline of this parameter. A functional parameter can be indicative of one or a plurality of measured values for this parameter. Moreover, a functional parameter can also be indicative of a development of a value of this parameter with time. A baseline for a functional parameter can refer then accordingly also to one or more values or to a development of the functional parameter. Generally, the baseline is indicative of the functional parameter under specific, known conditions. For example, the baseline can be indicative of a measurement of a functional parameter without the presence of water in the inner structure of the luminaire, with a specific amount of water in the inner structure of the luminaire, during a specific time of a day, during a specific environmental condition, etc. Preferably, the baseline is determined during a measurement of the functional parameter in a predefined setting at the manufacturer site, wherein in this case the same baseline can be provided to all luminaires with the same construction, i.e. referring to the luminaire model. However, a baseline can also be established at the customer site after the installation of the luminaire, for instance, by measuring the functional parameter at some time shortly after the installation with the expectation that a newly installed luminaire does not show a substantial water ingress.

Generally, the comparison of the functional parameter with the baseline can refer to any type of comparison of two values or functions with each other. For instance, as comparison a difference or a ratio of the functional parameter and the baseline can be determined. However, if the functional parameter and the baseline refer to a development of a value with time, i.e. a function, the comparison can also refer to comparing a waveform of the functions. For example, the comparison can be related to specific data points, to maxima or minima, to gradients, etc. of the function. The water ingress determination unit can then be adapted to determine the water ingress into at least a part of the inner structure of the luminaire based on the result of the comparison of the shape, i.e. waveform, or the specific data points of the sensed functional parameter function and the predetermined baseline function of the parameter. For example, a functional relation between the result of the comparison and the water ingress into the inner structure of the luminaire can be predetermined. Such a functional relation correlates one or more results of the comparison, for instance, with a specific amount of water within the inner structure of the luminaire. However, also a simple functional relation only providing a qualitative information on whether or not water ingress has been detected can be utilized. For example, the water ingress determination unit can be adapted to determine that water ingress has taken place when the comparison provides as result that a measured functional parameter differs from the baseline. However, the water ingress determination unit can also be adapted to apply more complex functional relations in which the result of the comparison is again compared, for example, to one or more thresholds, to determine an amount of water that is present in the luminaire. Such thresholds can be determined, for example, by experiments or simulations related to the functional parameter. Exemplarily, if the functional characteristic of the luminaire refers to an inside pressure of the luminaire, and it is known that water ingress destroys a part of the luminaire, if the value of the inside pressure influenced by the water ingress rises by 20% compared with a baseline inside pressure determined by the manufacturer, then the threshold can refer to 20% deviation from the baseline.

The predetermined baseline of the parameter can be a stored value, wherein the stored value can be a sensed value sensed by the sensing means or a calculated value. The water ingress determination unit can be adapted to receive the predetermined baseline of the parameter from a storage unit storing the predetermined baseline of the parameters. If the predetermined baseline of the parameter is stored at a storage unit, the storage unit can be located at the water ingress determination unit or at any other separate device or a cloud. If the storage unit storing the predetermined baseline of the parameter is not located on the water ingress determination unit, the water ingress determination unit can then be connected to the device storing the predetermined baseline of the parameter. For instance, the predetermined baseline of the parameter can be a series of values having been measured at different points in time of a day. The water ingress determination unit can then be adapted to determine water ingress into at least a part of the inner structure of the luminaire by comparing a sensed functional parameter with a stored predetermined baseline of the parameter at the same point in time of the day.

In a preferred embodiment, the baseline of the functional parameter is predetermined based on a parameter model that is adapted to model the functional parameter of the lighting unit with respect to an ambient environmental condition and/or an operational and/or a water ingress state of the lighting unit.

The operational state of the luminaire can refer to any state of the luminaire related to an operation of the luminaire. For example, the operational state of the lighting unit can be an on- or an off-state of the lighting unit. In an on-state the lighting unit provides light, wherein in the off-state the lighting unit does not provide light. The operational state of the lighting unit can also refer to any dim-state of the lighting unit, wherein a dim-state of the lighting unit refers to a state in which light with a predetermined light intensity is provided. The on-state of the lighting unit can also be understood as a dim-state. The operational state can also be a fully sleep state or a download state of the luminaire. A fully sleep state can be provided by a lighting unit being in an off-state, for instance, if receiving an external signal or if not receiving an external signal over a predetermined time period. In a fully sleep state, one or more functions of the lighting unit can be restricted, for instance, a provided illumination can only refer to an emergency illumination, a network capability or communication function can be restricted to the receiving of a wake-up signal, etc. The advantage of such a fully sleep state is a reduced power consumption of the lighting unit. The download state of the lighting unit can refer to a state in which the lighting unit receives, i.e. downloads, information, data, software updates etc. Preferably, the operational state of the lighting unit is an on-, an off- or a dim-state. The water ingress state can be any state of the luminaire with respect to a water ingress. For example, a water ingress state can refer to the amount of water that is present in the luminaire.

The parameter model can be any model being adapted to model a functional parameter in dependence on the ambient environmental condition and/or the water ingress state and/or the operational state. Preferably, the model is adapted to model a development of a value of the functional parameter with time. Exemplarily, in a case in which the functional characteristic refers to a temperature, the model can be understood as a temperature model adapted to simulate in at least a part of the inner structure of the housing of the luminaire a temperature at the site of the sensing means based on the ambient environmental condition and/or the water ingress state and/or the operational state, for instance, based on the amount of water within the inner structure of the housing of the luminaire and whether the luminaire is in an on- or off-state. Moreover, the model can also be adapted to take additionally further parameters into account, preferably constructional characteristics of the luminaire. Generally, a parameter model can be provided based on known physical relations between different physical quantities influencing a functional parameter of the luminaire. For example, the ideal gas law, thermal transport equations, etc. can be utilized for providing the mathematical background of the parameter model.

In an embodiment, the sensing means is adapted to sense the functional parameter of the luminaire at different operational states of the lighting unit and the water ingress determination unit is adapted to determine water ingress into at least a part of an inner structure of the luminaire based on a comparison of the functional parameters determined at different operational states of the lighting unit. For example, the sensing means can be adapted to sense a first functional parameter during an off-state and a second functional parameter during an on-state of the luminaire. The water ingress determination unit can then be adapted to determine the water ingress based on a comparison of the first and second functional parameters determined for the two different operational states. Generally, water ingress into the luminaire can have different effects on a functional parameter of the luminaire in different operational states of the luminaire. For example, water ingress can have an effect on a pressure or temperature difference between different operational states of the luminaire. Thus, a functional relation can be provided and utilized by the water ingress determination unit to derive water ingress from a comparison of the functional parameters sensed at different operational states of the luminaire.

In an embodiment, the functional parameter is indicative of a pressure within at least a part of the housing of the luminaire. For sensing the pressure, the sensing means is adapted to sense at least a functional parameter that is indicative of the pressure within at least a part of the housing. Preferably, the sensing means is adapted to directly sense a pressure within the housing of the luminaire. For instance, the sensing means can be positioned within the housing for sensing the pressure. The sensing means can in this embodiment refer to a piezoresistive strain gauge sensor, a capacitive pressure sensor, a piezoelectric pressure sensor, etc. Generally, the presence of water, in particular, in form of water vapor has an influence on a pressure reaction of the luminaire, for instance, to changes of environmental conditions or operational states.

In a preferred embodiment, the sensing means is positioned at the housing of the luminaire and is adapted to sense as functional parameter being indicative of a pressure within at least a part of the housing of the luminaire a deformation of at least a part of the housing. For instance, the functional characteristic of the luminaire can be a length, an area or a volume of a part of the housing indicative of the pressure within at least a part of the housing. In particular, changes of the length, the area or the volume of at least a part of the housing can be indicative of a pressure change within at least a part of the housing. In a preferred embodiment, the sensing means comprises at least a strain gauge sensor which is positioned at the housing or is part of the housing of the luminaire and is adapted to sense as functional parameter being indicative of a pressure within at least a part of the housing of the luminaire a deformation of at least a part of the housing. In particular, the strain gauge can be adapted to monitor a deformation of the luminaire housing due to a pressure differential to the outside of the housing. In an alternative, the sensing means can also comprise at least a MEMS pressure sensor or a piezo resistor or any other sensor being sensitive for a deformation of at least a part of the housing. Preferably, the sensing means is adapted to provide a pressure profile as functional parameter, wherein a pressure profile refers to a series of values measured over time indicative of the pressure within the housing. In an embodiment, a pressure profile measured during one day, for instance, a day directly after an installation of the luminaire, can be utilized as a predetermined baseline to which all following pressure profiles are compared to determine water ingress.

In a preferred embodiment, the housing comprises at least a flexible part and a rigid part, wherein the flexible part is more flexible than the rigid part, and wherein the sensing means is adapted to sense a deformation of the housing by sensing the deformation of the flexible part of the housing. Since in this embodiment the housing comprises at least a flexible part and a rigid part, wherein the flexible part is more flexible than the rigid part, a deformation of the flexible part of the housing due to a pressure difference to the environment will be more pronounced. This allows to measure the deformation of the housing more accurately and thus to provide a more accurate functional parameter. The more flexible part of the housing can be realized, for instance, by providing the flexible part with a different material than the rigid part, by providing the flexible part with a decreased thickness compared with the rigid part, by providing the flexible part with another structure, for example, with a number of recesses, etc. In a preferred embodiment, the sensing means comprises a copper track which is positioned on the surface of the flexible part that is adapted to act as a strain gauge sensor.

In an embodiment, the sensing means is adapted to sense as functional parameter being indicative of a pressure within at least a part of the housing of the luminaire a mechanical force applied to at least a part of the housing. For instance, the sensing means can be a piezo resistor to sense a mechanical force applied to at least a part of the housing. If mechanical forces, as they can originate from pressure changes within at least a part of the housing in comparison to the pressure outside the housing of the luminaire, affect the piezo resistor, the piezo resistor passively generates a voltage dependent on the mechanical force.

In a preferred embodiment, the housing comprises as a flexible part a rubber ring. The rubber ring can be adapted to seal the luminaire against water ingress. For example, if the housing is composed of two parts, the rubber ring can be being positioned between the two parts and adapted to seal the inner structure of the housing against water ingress. The sensing means, preferably at least one piezo resistor, being adapted to sense a mechanical force applied to the rubber ring by, for instance, a pressure differential between the inside and the outside of the housing of the luminaire, can be positioned in a direct contact with the rubber ring. In a preferred embodiment, the housing comprises at least two parts wherein a pressure differential between the inside and the outside of the housing of the luminaire leads to a pressure pressing the at least two parts of the housing against each other. In this embodiment it is preferred that a sensing means is provided such that the pressure between the at least two parts can be measured as indicator for the pressure within the housing. For example, if the at least two parts comprise a rubber ring in between, a piezo resistor can be positioned underneath the rubber ring, i.e. between one of the two parts of the housing and the rubber ring.

In an embodiment, the sensing means is adapted to sense as functional parameter a parameter indicative of a temperature of the luminaire. The temperature of the luminaire can be measured within at least a part of the housing of the luminaire by means of a temperature sensing means within the housing. Preferably, the temperature of the luminaire is measured within the housing of the luminaire and the value of the inside temperature can be compared to a previously measured value of the inside temperature or a predetermined baseline of the temperature. Moreover, the water ingress determination unit can be adapted to receive information on an outer temperature of the luminaire and the water ingress determination unit can be adapted to determine the water ingress further based on the outer temperature, for instance, based on a comparison of the outer temperature with the inner temperature.

In an embodiment, the functional parameter being indicative of a temperature of the luminaire refers to a temperature profile measured during a change of the lighting unit from one operational state to another. A temperature profile includes a series of values indicative of a temperature within at least a part of the housing of the luminaire, wherein the temperature values are measured, preferably, continuously, in a time period comprising a translation between two different operational states of the lighting unit. As already mentioned above, the operational states can refer to an on- or an off-state of the lighting unit or any dim-state of the lighting unit. The operational states can also refer to states of the lighting unit referring both to an on- or both to an off-state of the lighting unit, wherein, for instance, an operational state of the lighting unit can be a fully sleep state of the lighting unit in comparison to a downloading state of the lighting unit. The change of the operational state can refer to the change from any operational state of the luminaire to any other operational state of the luminaire. For instance, the temperature profile can be measured during a change from a dim-state to another dim-state, or from a dim-state to an off-state. The development of the temperature, i.e. the temperature profile, during the change from one operational state to another operational state can then be indicative of water ingress into the inner structure of the luminaire. For example, water ingress into the luminaire can change a thermal inertia of the luminaire, i.e. its reactiveness to changes of the temperature due to the change of an operational state. The water ingress determination unit can then be adapted to determine this change in thermal inertia based on the temperature profile, for instance, by comparing a currently measured temperature profile to a previously measured temperature profile or by determining characteristics of the temperature profile, like a gradient, maxima, minima, etc. and applying predetermined functional relations to determine water ingress. Preferably, the water ingress determination unit is adapted to determine water ingress into at least a part of an inner structure of the luminaire by comparing the sensed temperature profile with a predetermined baseline of the temperature profile, wherein the predetermined baseline of the profile is sensed by the temperature sensing means when no water is present in the inner structure of the luminaire. Additionally or alternatively, the water ingress determination unit is adapted to use a temperature model to predict the temperature profile for different water ingress states of the luminaire. The water ingress determination unit is then adapted to determine the water ingress by comparing the temperature profile with at least one temperature profile resulting from the temperature model, for instance, by determining a deviation of the sensed temperature profile to the temperature profile resulting from the temperature model.

In a preferred embodiment, the luminaire system further comprises a functional parameter providing unit adapted to provide a functional parameter with respect to another luminaire being part of the luminaire system or being external to the luminaire system, wherein the water ingress determination unit is adapted to receive the provided functional parameter and to determine water ingress into at least a part of the inner structure of the luminaire further based on the provided functional parameter. The functional parameter providing unit is adapted to provide functional parameters of another luminaire, preferably, of a plurality of other luminaires, wherein the water ingress determination unit is adapted to determine water ingress into at least a part of the inner structure of the luminaire based on the plurality of the provided functional parameters of the other luminaire or the plurality of other luminaires. The other luminaire or the plurality of other luminaires can be part of the luminaire system or can be external to the luminaire system being, for instance, part of another luminaire system.

The functional parameter providing unit can be a receiving unit for receiving the provided functional parameters of the other luminaire or the plurality of other luminaires. Additionally or alternatively, the functional parameter providing unit can also be a storage unit which stores the provided functional parameters of the other luminaire, preferably of a plurality of other luminaires, for instance, the functional parameter providing unit can be provided in form of a cloud storage. Additionally or alternatively, the water ingress determination unit can be adapted to receive provided functional parameters of other luminaires, preferably a plurality of luminaires, such that then the water ingress determination unit can be regarded as being a functional parameter providing unit. The functional parameter providing unit can be provided as a structural part of the luminaire, for instance, within a housing of the luminaire, or can be provided structurally separate from the luminaire, for instance, as part of a computation system in communication with the sensing means and/or the water ingress determination unit of the luminaire.

In a preferred embodiment, the water ingress determination unit of the luminaire is adapted to determine water ingress into at least a part of the inner structure of the luminaire further based on the provided functional parameters of the other luminaire, for instance, by applying anomaly detection algorithms. Preferably, the water ingress determination unit is adapted to determine water ingress into at least a part of the inner structure of one of the luminaires by comparing the functional parameter, for instance, the temperature profile, from the luminaire with the provided functional parameter of the at least one other luminaire or the plurality of luminaires. Generally, it can be expected that from a plurality of luminaires only a very few will be affected by water ingress such that other luminaires provide a good basis for determining a water ingress by monitoring changes between the different luminaires. Moreover, the functional characteristics of luminaires are influenced by external conditions, as for instance, weather conditions. Such conditions are mostly the same for all luminaires of the plurality of luminaires in a specific area such that differences of the functional parameters compared to a baseline determined in a laboratory caused not by water ingress but by the external conditions can be recognized when comparing the functional parameters of the plurality of luminaires. Thus, such differences caused by the external conditions can be taken into account when determining the water ingress and thus the water ingress can be determined more accurately. Preferably, if functional parameters of a plurality of other luminaires are provided, the water ingress determination unit is adapted to select from the plurality of provided functional parameters such from other luminaires being subjected to the same environmental conditions based on a monitoring of the functional parameters, information on a relative position of the luminaires, and/or environmental information. For example, the water ingress determination unit can be adapted to determine based on environmental temperature information for each luminaire that a group of luminaires is mostly provided in a shaded area, whereas another group of luminaires is subjected to intensive sunlight during a part of the day. The water ingress determination unit can then be adapted to determine water ingress into an inner structure of a luminaire by comparing the functional parameters of the luminaire with the functional parameters of one or more luminaires belonging to the same luminaire group.

In a preferred embodiment, the luminaire comprises a sensing means adapted to sense more than one functional parameter. In particular, the sensing means can be adapted to sense as first functional parameter a parameter indicative of a pressure within at least a part of the housing and as second functional parameter a parameter indicative of a temperature within the same part of the housing of the luminaire. The relation between the parameter indicative of the pressure within at least a part of the inner structure of the luminaire and the parameter indicative of a temperature within at least the same part of the inner structure of the luminaire can be calculated empirically by means of the ideal gas law PV=nRT, wherein P is the pressure, Vis the volume, n is the amount of substance, R is the ideal gas constant and T is the temperature. The water ingress determination unit can then be adapted to determine water ingress into at least a part of the inner structure of the housing of the luminaire based on the relation of the pressure P and the temperature T. Preferably, the water ingress determination unit is adapted to determine water ingress by comparing this relation with a value determined based on the ideal gas law for a case without water present in the inner structure of the housing of the luminaire. In another preferred variation, the ideal gas law can also be used to monitor the relation of a pressure profile and a temperature profile with respect to an operational state of the lighting unit, wherein water ingress is then determined based on a deviation of the sensed pressure and temperature profile in comparison to a baseline pressure and temperature profile determined with respect to an operational state of the lighting unit.

In an embodiment, a further sensing means is provided that is adapted to sense a humidity parameter indicative of a humidity within at least a part of the housing of the luminaire, wherein the water ingress determination unit is adapted to determine water ingress into at least a part of an inner structure of the luminaire further based on the humidity parameter. The humidity parameter can be indicative of a humidity within at least a part of the housing, i.e. to an amount of water present in the air within the part of the housing. However, the humidity parameter can also be indicative of an amount of water present in at least a part of the housing that is not present in the air, i.e. has condensed, within the housing. In particular, the humidity parameter is indicative of an absolute humidity or a relative humidity in at least a part of the housing. The relation between the absolute humidity H_{A} and the relative humidity H_{R} can be derived from the August-Roche-Magnus formula and the ideal gas law and is described by H_{A}=cH_{R}/T, wherein T is the temperature and c comprises physical constants and parameters being constant inside the housing. In a sealed housing the absolute humidity is constant and therefore the relative humidity changes with the temperature.

In one embodiment, the absolute humidity can be calculated by:

$${H}_{A} = \frac{{P}_{0} {e}^{- \frac{H}{RT}} {M}_{{H}_{2} O}}{RT} \frac{{H}_{R}}{100}$$

Here, P₀ is the partial vapor pressure at infinite temperature, H the water evaporation enthalpy, R the gas constant, M_{H}_{₂}_{O} the water molecular mass and T the temperature, wherein H_{A} and H_{R} are given in percentage. In particular, to calculate the absolute humidity, the following values can be used: P₀=1.002·10¹¹ N/m², H=42809 J/mol, R=8.31451/(K·mol), M_{H}_{₂}_{O}=0.0180153 kg/mol. The water ingress determination unit can be adapted to utilize this relation to determine whether the housing is still sealed, i.e. still fulfills the relation, or whether a water ingress has occurred leading such that the relation is not fulfilled anymore. Preferably, the sensing means comprises also a temperature sensing means and the water ingress determination unit is adapted to monitor a temperature profile and a humidity profile, sensed by the temperature sensing means and the further humidity sensing means, respectively, with respect to an operational state of the lighting unit. The water ingress determination unit can then be adapted to determine water ingress into at least a part of the inner structure of the luminaire based on the temperature profile in combination with the humidity profile with respect to an operational state of the lighting unit. In particular, water ingress into at least a part of the housing of the luminaire increases a thermal mass of the luminaire such that a temperature response inside the housing, i.e. changes of the temperature inside the housing due to changes of the temperature outside the housing, is retarded. In an embodiment, the temperature profile and humidity profile inside the housing are monitored over a certain time range, wherein the temperature profile and the humidity profile have a specific shape over the certain time range, for instance, due to a position of the sun heating the luminaire. In a closed housing, the relation between the temperature profile and the humidity profile can be described as defined by the relation above, wherein this relation can be used as a model. Water ingress can then be determined by the water ingress determination unit by comparing the model of the relation of the temperature profile and the humidity profile in the specific time range with the currently measured temperature and humidity.

In an embodiment, the housing comprises a sinkhole provided such that water present in the housing will accumulate in the sinkhole, wherein the further sensing means is adapted to sense the presence of water in the sinkhole. The sinkhole can, for instance, be understood as a cavity opened at the top and closed at the bottom comprising a volume to collect water which has ingressed into at least a part of the housing. In particular, the housing which comprises walls with inner and outer surfaces is shaped such that an amount of water which has condensed in at least a part of the housing can reach the sinkhole, for instance, moved by gravity acting on the condensed water. For example, the water can ingress into at least a part of the housing as liquid water or as gaseous water, wherein in case of gaseous water the water molecules are distributed in the air which can ingress into the housing. In such a case, the water can condensate on the inner surface of the housing and be pulled down in direction of the sinkhole by a gravitational force such that the water accumulates at the inner surface of the wall of the housing and/or in the sinkhole. Preferably, the sinkhole includes the deepest point of the housing in relation to the ground such that water can reach the sinkhole only by being subjected to the gravitational force.

The further sensing means can be any sensing means which can sense a functional characteristic of the volume included in the sinkhole influenced by the presence of water in the sinkhole. For instance, the further sensing means can comprise electrodes connected to an electronic circuit and positioned at the sinkhole such that as a functional characteristic a conductivity and/or resistance of the volume included in the sinkhole can be monitored which is influenced by the presence of water in the sinkhole. Preferably, the functional parameter indicative of a functional characteristic can be a resistance or a capacitance sensed by the electrodes and the electronic circuit. The functional parameter can also be any other electrical quantity related to a functional characteristic of the volume included in the sinkhole and influenced by water in the sinkhole. The water ingress determination unit is then adapted to determine water ingress into at least a part of the inner structure of the luminaire further based on the results of the humidity, in this case, water, measurement in the sinkhole. For example, the amount of water measured in the sinkhole can be compared with the amount of water determined from the other functional parameters to determine a reliability of the water ingress determination or to increase the accuracy of the water ingress determination.

Additionally or alternatively to a sinkhole, the housing can comprise a moisture holding substrate, wherein the further sensing means is adapted to sense the humidity parameter by sensing an electrical parameter of the moisture holding substrate. A moisture holding substrate can be any substrate which is adapted to incorporate moisture, i.e. water, from an environment. In a preferred embodiment, the moisture holding substrate comprises a salt or conductive plastic polymer. The moisture holding substrate is positioned in at least a part of the housing. The further sensing means can include electrodes and an electronic circuit to monitor an electric quantity like a capacitance or a resistance of the moisture holding substrate which is influenced by the amount of water which is incorporated into the moisture holding substrate as moisture. In a preferred embodiment, the electrodes are arranged such that the moisture holding substrate is sandwiched by the electrodes. Alternatively, the electrodes can also be arranged side by side with the moisture holding substrate in between. The water ingress determination unit is then adapted to determine water ingress into at least a part of an inner structure of the housing where the moisture holding substrate is positioned, based on the sensed functional parameter of the electrodes.

According to a second aspect of the invention, a method for determining water ingress into at least a part of an inner structure of a luminaire is presented, wherein the method comprises the steps of a) providing measurements of a functional parameter of a luminaire comprising a lighting unit and a housing containing at least a part of the lighting unit, wherein the functional parameter is indicative of a functional characteristic of the luminaire that is influenced by water ingress into at least a part of an inner structure of the luminaire, and b) determining water ingress into at least a part of the inner structure of the luminaire based on the sensed functional parameter.

According to a further aspect of the invention, a computer program product for determining water ingress into a luminaire is presented, wherein the computer program product comprises program code means causing a computer to execute the method according to the invention.

It shall be understood that the luminaire system, the method and the computer program product have similar and/or identical preferred embodiments, in particular, as defined in the dependent claims.

It shall be understood that a preferred embodiment of the present invention can also by any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically and exemplarily a luminaire system,

FIG. 2 shows schematically and exemplarily a method for determining water ingress into a luminaire,

FIGS. 3A-3C, 4A-4C and 5 show schematically and exemplarily aspects of preferred embodiments of the invention,

FIG. 6 shows schematically and exemplarily a graph illustrating principles of an embodiment for determining water ingress into the luminaire, and

FIGS. 7A and 7B show schematically and exemplarily an aspect of another preferred embodiment of the invention comprising a moisture holding substrate.

### DETAILED DESCRIPTION OF EMBODIMENTS

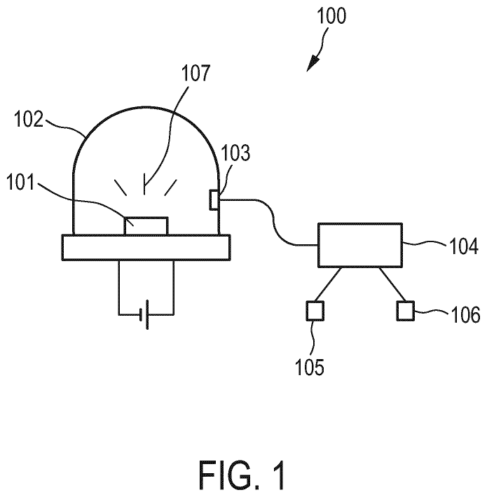

FIG. 1 shows schematically and exemplarily a luminaire system 100 with an improved persistence and safety. The luminaire system 100 comprises a lighting unit 101 for providing light 107. The lighting unit 101 can comprise, for instance, an LED and circuitry for controlling the LED and for providing power to the LED. However, the lighting unit 101 can also comprise any other light source that can provide light 107. Optionally, the lighting unit 101 comprises also a controlling unit realized, for instance, as dedicated hardware or as software running on a general computation device, wherein the controlling unit is adapted to control the lighting unit 101, in particular, to control the light 107 provided by the lighting unit 101. However, the control unit can also be adapted to control other functionalities of the lighting unit 101, if provided by the lighting unit 101.

Further, the luminaire system 100 comprises a housing 102 encompassing in this example the LED and at least a part of a circuitry provided together with the LED as part of the lighting unit 101. Preferably, the housing 102 comprises a transparent part, for instance, a dome shaped part shown in FIG. 1, and a non-transparent part, for instance, the part below the lighting unit 101 shown in FIG. 1, which can be regarded as a construction basis to which the lighting unit 101 can be attached and that provides stability to a luminaire formed at least by the lighting unit and the housing. Generally, the housing 102 can take a wide variety of forms and designs that are determined and selected based on the intended application of the luminaire and the fixing system chosen for the respective luminaire. Further, the luminaire system 100, in particular, the luminaire defined by the lighting unit 101 and the housing 102, comprises at least a sensing means 103, wherein the sensing means 103 is adapted to sense a functional parameter indicative of a functional characteristic of the luminaire that is influenced by water ingress into an inner structure of the luminaire, for instance, into the housing 102 of the luminaire and/or into the circuitry of the lighting unit 101. A functional parameter measured by the sensing means 103 can refer to any parameter that allows to infer the influence of water ingress onto a functional characteristic of the luminaire. For example, the functional parameter can refer to a temperature measured within the housing 102 of the luminaire, wherein changes in the measurement of the temperature as provided by the sensing means 103 as functional parameter can be indicative of water that has ingressed into the housing 102 of the luminaire. However, also other functional parameters can be measured by the sensing means 103, for instance, parameters like a pressure within the housing 102 of the luminaire, a deformation of the housing 102 of the luminaire, etc. The sensing means 103 can then be realized in accordance with the functional parameter that should be measured by the sensing means 103. For example, if the functional parameter is selected to refer to a temperature within the housing 102, the sensing means 103 can be embodied by any known temperature sensor, for instance a thermocouple. Moreover, if a pressure should be detected as functional characteristic of the luminaire, the sensing means 103 can be embodied by any pressure sensor, for instance, by a piezoelectric sensor, that allows to determine the pressure, or pressure differences within the housing 102.

The luminaire system 100 comprises further a water ingress determination unit 104 which can be realized as dedicated hardware or as software running on a general computation system. The water ingress determination unit 104 can be provided as part of the luminaire, for instance, incorporated into a circuit board that is also utilized for providing circuitry for controlling the lighting unit 101 of the luminaire. However, the water ingress determination unit 104 can also be provided outside of the luminaire, in particular, on a different device, like a user device. In a preferred embodiment, the water ingress determination unit 104 is realized as a software application running on a user computation system like a smart phone, a server, a laptop, etc. Generally, the water ingress determination unit 104 is adapted such that it can receive the functional parameters sensed by the sensing means 103 of the luminaire system 100. For example, the water ingress determination unit 104 can directly be connected with the sensing means 103, for instance, via a wired connection provided on a circuit board, or via a wireless connection between the sensing means 103 and the water ingress determination unit 104, or via a non-direct connection utilizing an intermediate system, like a server to which the luminaire provides the functional parameters measured by the sensing means 103, a storage in which the sensed functional parameters are already stored, a gateway connecting the sensing means 103 with the water ingress determination unit 104, etc. Optionally, the water ingress determination unit 104 can further comprise an input unit 105 such as the keyboard, a switch, a contact sensor, etc. and/or an output unit 106 such as a display, light output system, audio output system, etc.

The water ingress determination unit 104 is adapted to determine the water ingress into at least a part of the inner structure of the luminaire based on one or more sensed functional parameters. For example, the water ingress determination unit 104 can utilize a functional relation between a sensed functional parameter and an amount of water present in at least a part of the inner structure of the luminaire, for example, present in the housing 102. Such a functional relationship can be provided to the water ingress determination unit 104 from a storage storing the functional relation. Generally, such a functional relation can be determined based on experiments performed, for instance, at a construction site with luminaires of the same type. In this context, a plurality of functional parameters of the luminaire can be measured with different amounts of water present within the housing 102 of the luminaire. From such measurements a functional relation can then be determined with known statistical methods and can be provided, for instance, in form of a mathematical relationship, a look-up table, or a set of rules that can be applied by the water ingress determination unit 104 to the functional parameters measured by the sensing means 103.

The result of the water ingress determination of the water ingress determination unit 104 can refer, for instance, to determining an absolute or relative amount of water present within at least a part of the luminaire. However, the result can also be a simple determination on whether water is present inside at least a part of the luminaire or not. The result of the water ingress determination can then be provided by the water ingress determination unit 104 to a user, for instance, by utilizing the output unit 106 and can refer, for instance, to a visible or audible output indicating that water is ingressed into the luminaire. Moreover, the output can also refer to providing additional information with respect to the determined water ingress, like an estimate on how seriously functions of the luminaire might be affected by the water ingress, whether or not a user should contact an installer for fixing or exchanging the luminaire or parts of the luminaire, etc. Additionally or alternatively, the water ingress determination unit 104 can also be adapted to provide the result of the water ingress determination to the luminaire itself, for instance, via a wired or a wireless communication with the luminaire such that a controller of the luminaire, in particular, a controller of the lighting unit 101, can utilize the results of the water ingress determination to control the luminaire, in particular, the lighting unit 101 of the luminaire. For example, if the water ingress determination unit 104 determines as result of the water ingress determination that the amount of water present in the inner structure of the luminaire might provide a safety risk, for instance, due to the possibility of occurring short-circuits, this information can be utilized by a controller of the luminaire for causing a switching off of a power supply of the luminaire. In an embodiment, a water ingress determination result can also be utilized by a controller for controlling the lighting unit 101 based on the water ingress determination result. For example, the controller can be configured to adapt, i.e. increase or decrease, a light intensity of the light 107 provided by the lighting unit 101 based on the water ingress determination result. Moreover, a controlling of the lighting unit 101, for instance, by a controller, can also be utilized to indicate the water ingress determination result to a user, for instance, by changing a color of the light 107 provided by the lighting unit 101, by providing a kind of blinking pattern of the light 107 provided by the lighting unit 101, etc., at certain times, for instance, shortly after switching on the lighting unit 101.

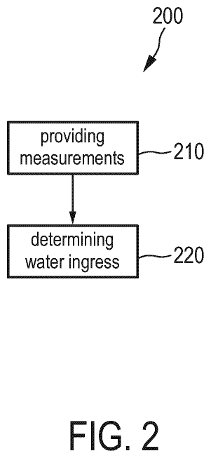

FIG. 2 shows schematically and exemplarily a method for determining water ingress into a luminaire. The method 200 comprises a first step 210 of providing measurements of a functional parameter of a luminaire, for instance, the luminaire as described with respect to FIG. 1. The measurements can be provided, for example, by the sensing means 103 of the luminaire. However, the measurements can also be provided by a measurement providing unit that can be realized, for instance, as a storing unit storing the measurements of the sensing means 103. Further, the method comprises a step 220 of determining water ingress into at least a part of the inner structure of the luminaire based on the sensed functional parameter, for instance, utilizing a water ingress determination unit 104 as described above. Optionally, the method 200 can further comprise a step of providing the results of the water ingress determination to a user, for instance, utilizing the lighting unit 101 of the luminaire or an output unit 106 of the water ingress determination unit 104. Additionally or alternatively, the method can also comprise a step of controlling the lighting unit 101 of the luminaire based on the results of the water ingress determination utilizing, for instance, a controller of the lighting unit 101.

In the following, some preferred embodiments will be described in more detail. In a preferred embodiment, the sensing means 103 is adapted to monitor as functional parameter a deformation of the luminaire housing 102 caused by humidity-induced increased pressure differentials. Generally, a sealing of a luminaire, for instance, a housing 102, strongly reduces the ability of the luminaire to reduce pressure fluctuations in a fast manner, both for positive fluctuations, i.e. over pressure, and negative fluctuations, i.e. vacuum. It is generally known that pressure differentials occur when a luminaire turns on and off. Moreover, it is also generally known that such pressure differential can be utilized to determine whether a sealed luminaire is able to hold a pressure differential which can be an indicator for the existence of a leak path to the outside environment.

In this context, it can be observed that also water ingress modifies the general pressure fluctuation behavior of a luminaire independent on the presents of a leak path. Thus, it is preferred that the sensing means 103 in one embodiment is adapted to provide as functional parameter a pressure profile, more preferably a pressure-differential profile, i.e. a profile of the pressure difference between an inside of the luminaire, for example, of the housing 102, and the outside of the luminaire, resulting from monitoring a pressure within the luminaire, for example, within the housing 102 over a time period, preferably over 24 hours. The water ingress determination unit 104 is then adapted to compare the pressure profile with a baseline pressure profile determined when no water is present in the inner structure of the luminaire, for instance, determined directly after an installation of the luminaire. Based on this comparison, in particular, based on differences between the two profiles, the water ingress determination unit 104 can then be adapted to determine if water ingress has occurred, i.e. if water is present in the luminaire.

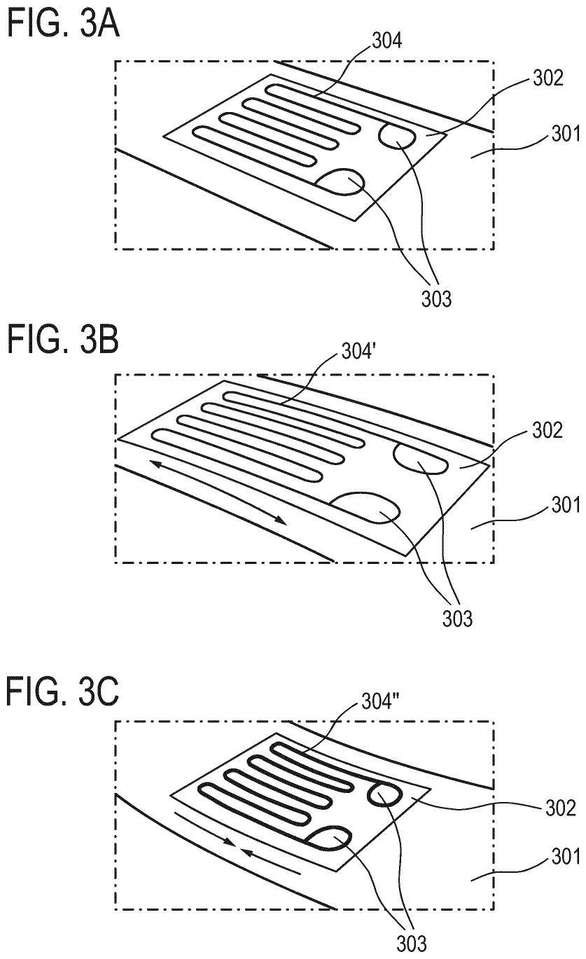

In an embodiment, the sensing means 103 is adapted to provide as functional parameter a pressure profile of a luminaire without actually measuring the pressure. FIGS. 3A-3C shows an embodiment, in which the sensing means 103 refers to a strain gauge 302 placed on a luminaire surface 301 of the housing 102 as shown in FIG. 3A without deformation. Utilizing the deformation of the strain gauge 302 as shown schematically in FIGS. 3B and 3C for a positive and negative deformation, a deformation of the luminaire housing 102 due to a pressure differential to the outside environment can be measured. As shown in FIGS. 3A-3C the strain gauge 302 as sensing means is preferably provided with a strain sensitive pattern of an electrical conductor 304 provided with terminals 303 at the end of the conductor 304 at which the electrical properties of the conductor 304 can be determined. As shown in FIG. 3B, a deformation of the housing 102 resulting in a tension leads to an elongation of the strain gauge 302 and therefore to a narrowing of the conductor 304′ and thus to an increase of an electrical resistance at the terminals 303, whereas, as shown in FIG. 3C a deformation resulting in a compression leads to a shortening of the strain gauge 302 and therefore to a thickening of the conductor 304″ and thus to a decrease of the electrical resistance at the terminals 303. Therefore, a strain gauge 302 provides an easy and simple possibility to measure a pressure differential between the inside of the luminaire and an outside of the luminaire.

In a preferred embodiment, a part of the luminaire housing 102 is provided to be more flexible than the rest of the housing 102 to enhance the deformation due to pressure differentials. The sensing means 103 can then be placed on the surface of the more flexible part, i.e. this deformable luminaire part, for instance, in form of copper tracks acting as a simple strain gauge.

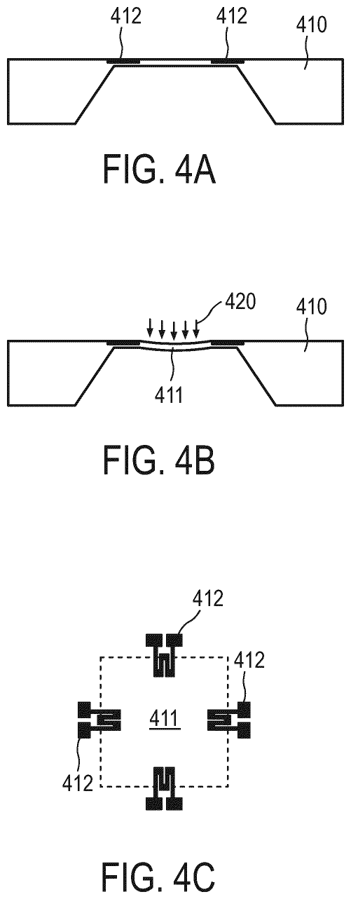

The sensing means 103 can in this example also be provided in form of a MEMS pressure sensor as shown in FIGS. 4A-4C. In this example, piezoresistive sensors 412 constructed in accordance with the strain gauge principles are applied at edges between the more flexible part 411 and the rest of the housing 410. Preferably, for a MEMS sensor the more flexible part 411 refers to a thin silicon membrane that upon a deformation 420 changes the piezo-resistance of piezoresistive sensors 412 at the edges of the flexible part 411.

As alternative to strain gauges, also piezo resistors can be utilized as sensing means 103 in order to measure mechanical forces on a certain luminaire housing part due to the pressure differential with the exterior environment. A piezo resistor passively generates a voltage dependent on the degree of mechanical deformation it experiences.

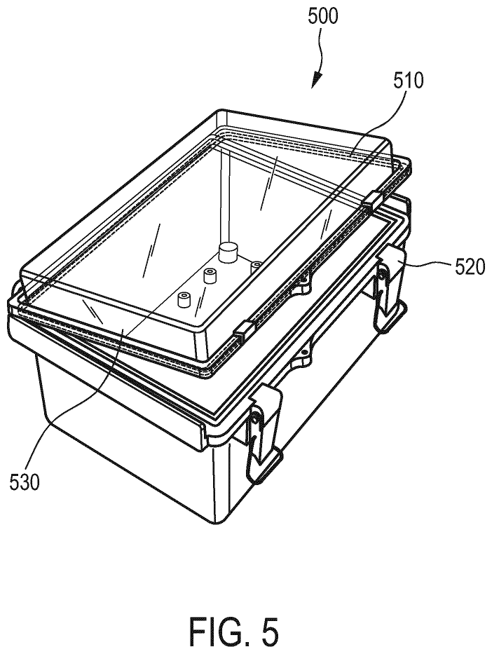

FIG. 5 shows an embodiment of a typical watertight luminaire housing 500. In watertight luminaire housings, typically a flexible rubber seal 510 is provided between different parts of the housing 530, 520 and used to make the housing watertight. In this embodiment, a part of the rubber seal 510 can be provided with the sensing means 103, for instance, in form of a piezo resistor. Due to the generally flexible nature of the rubber seal 510, if there is a positive pressure differential to the outside environment, the rubber seal 510 will be mechanically expanded in direction of the two parts of the housing 530, 520, wherein this expansion can then be measured by the sensing means 103. In a specific embodiment, the sensing means 103, for instance, in form of a piezo resistor, can be placed in direct contact with the rubber seal 510 and thus be adapted to measure the expansion of the seal, wherein then the degree of the expansion of the rubber seal 510 is indicative of the pressure differential between the inside of the luminaire and the outside. In another specific embodiment, the downwards force on the luminaire cover, i.e. seal, shown in see FIG. 5 can be measured as functional parameter. For instance, if the external pressure on the luminaire is higher than the internal pressure within the luminaire, this leads to a force on the luminaire cover 530, i.e. the upper housing part. The sensing means 103 can then be adapted to monitor as functional parameter this force, wherein the sensing means 103 can be a piezo resistor that is placed directly underneath the rubber seal 510, i.e. in between the rubber seal 510 and a part of the housing, for example, the lower housing part 520. Additionally or alternatively, an additional mechanical part, for example, a pole, can be positioned vertically between the upper housing part 530 and lower housing part 520. If the pressure on the housing or on the parts of the housing, increases, the sensing means 103, for example, a piezo resistor, located underneath this pole, i.e. between the pole and a part of the housing 530, 520, can be adapted to detect the presence of a substantial pressure differential. Based on these measurements the water ingress determination unit 104 can then be adapted inferring water ingress.

In an embodiment, the development of the pressure differential over time inside and outside at least a part of the housing is measured. A pressure differential can be caused by environmental changes as, for instance, temperature changes of the ambient temperature by sun light such that for a closed housing a baseline pressure differential can be recorded with a specific shape. Exemplarily, the baseline pressure differential comprises a daily repeated shape dependent on sun rise and sun dawn. In case of a substantially closed housing, the pressure differential is much higher in comparison to a substantially leaky housing such that water ingress originating from the leaky housing in at least a part of the housing can be determined by determining deviations of the pressure differential from the baseline pressure differential.

In an embodiment the ideal gas law can be utilized by the water ingress determination unit for determining water ingress. The ideal gas law is often written in the empirical form as:

PV=nRT,

where P, V and T are the pressure, volume and temperature, respectively, n the amount of substance, and R is the ideal gas constant. In case of a sealed luminaire, the gas volume is per definition constant while the temperature and pressure of the gas can vary. For example, after a luminaire, in particular the lighting unit, has transitioned from an on- to an off-state, the heat dissipation by the lighting unit and power circuitry stops. Hence, the luminaire's internal temperature will decrease according to a specific temperature and pressure profile, which is dependent on both the luminaire- and external environment temperature. Water ingress into the luminaire alters the temperature and pressure profiles during the change of the states of the luminaire. For instance, when a luminaire has suffered from water ingress, gas will be leaving and entering the housing during a cool down phase of the luminaire. Thus, if water is present in the fixture, i.e. the luminaire, the thermal and pressure profiles within the luminaire housing will deviate from the normal baseline profile recorded without the presence of water, for instance, during a product release of the luminaire or previously measured for this specific luminaire in the field before the water ingress event has occurred. As already described above, a pressure profile can be monitored by the sensing means in a plurality of ways, for example, by utilizing a MEMS pressure sensor. For monitoring the temperature profile the sensing means can alternatively or additionally be provided with a respective temperature sensor, for instance, a thermocouple.

It has further been observed that accumulated water or humid air within the housing of the luminaire can increase the thermal mass of the luminaire, i.e. the ability of the luminaire to adapt its temperature with respect to respective temperature stimuli. Hence, when compared to a dry luminaire baseline, the presence of water will slow the speed of temperature changes of the luminaire when, for instance, a functional state of the luminaire is changed. For example, the speed with which a luminaire adapts to a new temperature in an event of a transition between different dim-levels, i.e. dim-states, will be decreased. Thus, the presence of water can have an influence on a temperature transition profile of a luminaire.

Accordingly, in an embodiment the sensing means is adapted to measure a temperature profile, i.e. a temperature over time, as functional parameter within the luminaire. For instance, the temperature profile can be easily measured, when the sensing means refers to an embedded temperature sensor in any microcontroller located within the housing, or to a dedicated thermocouple within the luminaire. Moreover, it is preferred that both a humidity and a temperature is measured by a sensing means referring, for instance, to a single MEMS sensor. The compact dimensions of a MEMS sensor allow for a simple integration with existing electronic circuitry in the lighting unit.

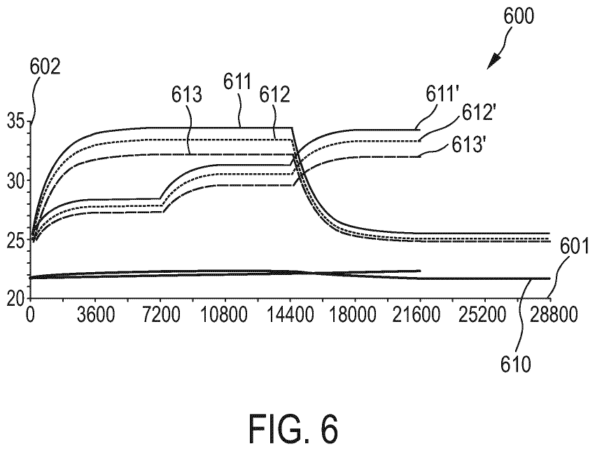

FIG. 6 shows experimental results for a sealed luminaire. The diagram 600 shows thermal models of different temperature response curves as recorded by three different internal temperature sensors within a housing of the luminaire representing on/off dimming transitions 611, 612, 613 and various dimming steps 611′, 612′ 613′ of a sealed outdoor luminaire. Since the thermal models provide a very well fit of the measured temperature response curves, the original measured temperature response curves are not visible “behind” the thermal model curves. The y-axis 602 represents a temperature and the x-axis 601 represents a time. An external air temperature 610, i.e. an environment temperature, measured in the environment of the luminaires during the transitions is shown on the bottom of the diagram.

From the measured internal temperatures for each case an empirical thermal model of the luminaire's response to dim-state transitions can be created for each transition. When switching the lighting unit from an off- to an on-state, the temperature inside the luminaire will be increased by a certain temperature, because the lighting unit engine and driver dissipate heat. The temperature increases exponentially as a function of time. The same principle can be used when the inside of the luminaire cools down when switching the lighting unit off. For example, for the temperature during an on/off transition, the model can be determined from the measured temperature profile by applying the following equation and determining the respective constants of the equation from the measured temperature profile:

$$T ( t ) = {T}_{0} + ( {T}_{end} - {T}_{0} ) {e}^{\frac{- t}{τ}}$$

Here, T refers to the temperature, t to the time, T₀ to the temperature inside the luminaire in the initial state, T_{end} to the temperature inside the luminaire in the state to which it is switched and r to the time constant. The time it takes to reach this state of thermal equilibrium depends on the heat capacitance of the luminaire that determines the time constant τ. T_{end}−T₀ describes a certain temperature increase/decrease due to an on/off transition due to the lighting unit engine and driver dissipating heat. In case of a leaking luminaire, the actual temperature profile will deviate from the expected profile based on the thermal model. Exemplarily, for the experimental results shown in FIG. 6, the thermal model refers to:

$${T}_{i} ( t ) = {T}_{i 0} + ( {T}_{i , end} - {T}_{i , 0} ) ( 1 - {e}^{\frac{min ( - t , 0 )}{1100}} )$$

Here, the index i refers to the respective measurement. The min (−t,0) operator enables for positive t to use a part of the exponential curve to model the heat up, wherein in case of a negative t the result of the model function is constant and refers to the initial temperature T₀ or Tᵢ₀.

As pointed out above, water ingress will change the thermal properties of the luminaire, hence the measured dynamic temperature profile recorded after the fixture, i.e. the luminaire, which has transitioned to a new dim-state will start to deviate from the modelled baseline profile measured without water ingress. Thus, the water ingress determination unit can be adapted to determine water ingress based on a comparison of a measured temperature profile during a transition between two functional states of the luminaire and the modeled baseline profile for this transition.

As demonstrated in FIG. 6, the modeled baseline temperature profiles provide an accurate fit of the temperature measured by sensing means during transitions between different luminaire dim-states. It is therefore preferred that the water ingress determination unit is adapted to apply a change detection algorithm on the temperature profile measured by the sensing means, being here a temperature sensor, to infer water ingress and/or air leakage, for instance, due to leaks in the housing. As demonstrated in FIG. 6 by three different sensor locations, for this embodiment the placement of the sensing means is non-critical and the sensing means can be provided in any location that allows to infer a temperature within the inner structure of the luminaire.

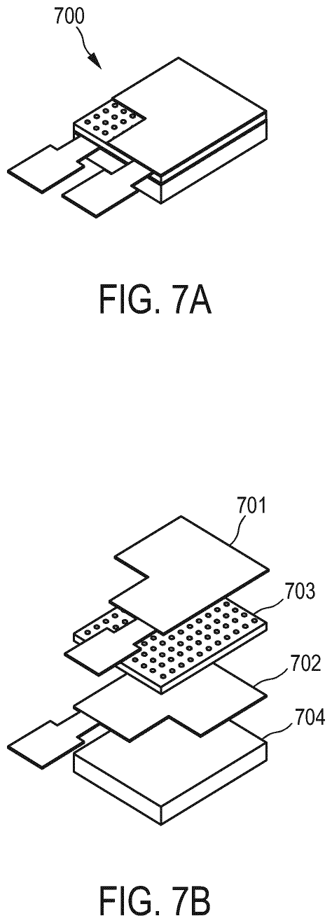

FIGS. 7A and 7B show schematically and exemplarily an aspect of another preferred embodiment of the invention comprising a moisture holding substrate. In this embodiment, the sensing means in the luminaire is a humidity sensor 700 and comprises preferably an upper electrode 701 and a lower electrode 702 which sandwich the moisture holding substrate 703. The moisture holding substrate 703 is preferably a salt or conductive plastic polymer and can be positioned with the electrodes 701, 702 on a glass substrate 704. The moisture holding substrate 703 releases ions if water vapor, i.e. water molecules of humid air, is absorbed by the moisture holding substrate 703 such that the conductivity between the electrodes 701, 702 is increased. The change of the resistance between the two electrodes 701, 702 is proportional to the relative humidity in at least a part of the housing of the luminaire. Higher relative humidity decreases the resistance between the electrodes 701, 702, while lower relative humidity increases the resistance between the electrodes 701, 702.

In an embodiment, the water ingress determination unit can be adapted to estimate an outside air-temperature based on the temperature measurements of a sensing means within the inner structure of the luminaire by utilizing the empirical thermal model. In this case, the water ingress determination unit can be adapted to determine that water is present in the inner structure of the luminaire when the estimated outdoor air temperature for the luminaire differs from a real outdoor temperature. A real outdoor temperature can be provided to the water ingress determination unit, for example, by a connection to a weather service or an averaged air temperature determined by other luminaires in the vicinity and in communication with the water ingress determination unit.

In an embodiment, the water ingress determination unit can be adapted to determine the relative humidity inside the luminaire as a function of the temperature inside the luminaire as well as the extent of the accumulated water. When the temperature increases during the day, more water may gradually evaporate, leading to a cooling effect. The accumulated water may completely evaporate. When all the water has evaporated, the humidity profile and temperature profile of the luminaire will show a distinct kink and the relative humidity will drop when the temperature inside the luminaire further increases. Based on the presence of the kink, the amount of water ingress can be inferred, e.g., moderate water ingress which evaporates during the day but returns when the temperature inside the luminaire decreases, wherein water ingress of a large amount of water significantly changes the thermal mass of the luminaire. The relative humidity also gives insights in the condensation inside the luminaire. The advantage is that leakage of the housing can be measured without needing to know the external temperature of the luminaire such that also occurrence of condensation can be measured in a closed and a leaky luminaire housing.

In an embodiment, the water ingress determination unit can be adapted to determine also minor water ingress events merely leading to some condensation. Generally, for inferring that condensation occurs inside a certain luminaire an understanding when and where the relative humidity inside the luminaire volume reaches 100% can be utilized. Condensation depends, for instance, on the temperature, the amount of water vapor present inside an inner structure of the luminaire and a resistance against water vapor diffusion from the enclosed luminaire volume towards the ambient. Temperature differentials between the inside and the outside of the luminaire can lead to cold-spot condensation within the inner structure of the luminaire. Such temperature differentials between the inside and the outside of a luminaire can be triggered by either a change of external air temperature or internal temperature within the luminaire, or both. Sometimes external temperature changes can be even dramatic, for instance, in case of a sudden thunderstorm on a hot summer day. When the temperature inside the luminaire drops rapidly, also the relative humidity in the inner structure of the luminaire will increase if the water vapor inside cannot be exchanged with the outside environment fast enough, depending, for instance, on the total volume of the housing and an ambient temperature drop, condensation inside the luminaire will occur. The condensation will then take place in areas with the lowest temperature inside the luminaire.

In an embodiment, external events leading to dramatic temperature changes (e.g. a thunderstorm) are most likely to cause condensation and hence provide a good opportunity for the proposed sensing method to assess whether a specific luminaire has accumulated water. For example, functional parameter measurements like measurements of an internal temperature, humidity and/or resistivity of a sinkhole can be recorded over a predetermined time period, for instance, over many weeks and/or months. In this case, similar external events like a series of thunderstorms can lead to similar shapes of the respective measurements of the functional parameter, whereas the similarity of the events, for instance, thunderstorms can be judged based on local weather data from another source, like the internet or additional weather sensors in the vicinity. In such a case, a change detection algorithm can be applied for detecting whether or not a change of the luminaire characteristic has occurred during the similar events and it can be derived by the water ingress determination unit when such change has occurred indicating the time of the water ingress. A change of the luminaire thermal and/or pressure behavior indicates that water ingress has occurred while previously the luminaire interior was dry. Optionally, the data of a group of identical luminaires e.g. on a street or in a city may be used for discerning whether a change has occurred in one of the luminaires.

In an embodiment, functional parameters from a large number of luminaires, preferably located in relative vicinity, are recorded and an anomaly detection algorithm can be applied to the recorded measurements. The records, i.e. the functional parameters of the other luminaires, can be stored and/or provided to the water ingress determination unit by a functional parameter providing unit. As water ingress is a rare event occurring only at a small subset of luminaires, the functional parameters of a luminaire suffering from water ingress will differ significantly from the majority of the functional parameters from the other “healthy” luminaires. Different anomaly detection techniques may be applied by the water ingress determination unit such as an unsupervised anomaly detection technique, a supervised anomaly detection technique or a semi-supervised anomaly detection technique. The unsupervised anomaly detection technique comprises detecting anomalies in an unlabeled measurement data set under the assumption that the majority of the instances in the measurement data set from the various luminaires are normal by looking for instances that seem to fit least to the remainder of the data set. The supervised anomaly detection technique comprises labeling a data set as “normal” and another data set as “abnormal” and train an algorithm to classify further data sets as “normal” or “abnormal”. The semi-supervised anomaly detection technique can comprise steps of both previously described techniques.

In an embodiment, the sensing means can additionally be adapted to measure condensed water or moisture directly. In such an embodiment the luminaire, in particular, the housing is adapted such that condensed water is collected in a sinkhole, e.g. by gravity when the humid air condenses due to low temperatures. The sinkhole is then monitored by the sensing means for presence of water. The sensing means can in this case refer, for instance, to two pads connected to an electronic circuit creating a short circuit between the two pads in the presents of water. However, instead of a sinkhole, a moisture or water holding substrate can also be provided in the luminaire. In this case the sensor means can refer to two electrodes placed in contact with the water or moisture holding substrate such that the sensing means can monitor the resistance of the water or moisture holding substrate. The water ingress determination unit can then be adapted to detect the presence of condensed water using the measurements performed by the sensing means. Moreover, the water ingress determination unit can be adapted to use the directly measured condensed water to verify a result of the water ingress determination based on the functional parameters. In particular, the water ingress determination unit can be adapted to take the results of the directly determined condensed water additionally into account when determining an amount of water in the inner structure of the luminaire based on the functional parameters. For example, functional relations between the amount of condensed water, the amount of water vapor and a functional parameter of the luminaire can be utilized by the water ingress determination unit.

Although in the above mentioned embodiments, the lighting unit comprises an LED as light source, also any other lighting unit can be used, as for instance, a halogen lamp, a fluorescent lamp, etc.

Although in the embodiment of FIG. 1, the housing of the luminaire comprises as transparent part a dome shaped part, in other embodiments of a luminaire the transparent part of the housing can be planar as, for instance, for spot lights which can be exemplarily used as in-road lights.

Although in the above mentioned embodiments often water ingress is determined in the housing of the luminaire, water ingress can also be determined in only a part of the housing, the whole housing, an inner structure of the housing, etc.

Although in the above mentioned embodiments, the luminaire system often comprises only one luminaire, a luminaire system can also comprise a plurality of luminaires. In such a case, it is preferred that a plurality of luminaires performs a task together, for instance, illuminating a way, a road, etc. or are used to guide road users in direction of, for instance, an escape or emergency exit, etc. Moreover, the luminaire system can also be adapted to communicate with other luminaire systems, for instance, as part of a network of luminaire systems. In both embodiments, it is preferred that the water ingress determination unit of a luminaire is adapted to receive functional parameters of more than one luminaire and to determine water ingress into a luminaire based on a comparison of the functional parameters of different luminaires.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Procedures like the determination of the water ingress into a luminaire, the controlling of the lighting unit of the luminaire, et cetera, performed by one or several units or devices can be performed by any other number of units or devices. These procedures can be implemented as program code means of a computer program and/or as dedicated hardware.

A computer program product may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

The invention relates to a luminaire system comprising a lighting unit, a housing containing at least a part of the lighting unit, wherein the lighting unit and the housing are parts of a luminaire, and a sensing means positioned at or within the housing, wherein the sensing means is adapted to sense a functional parameter indicative of a functional characteristic of the luminaire that are influenced by water ingress into at least a part of the luminaire. Further, the luminaire system comprises a water ingress determination unit being adapted to determine water ingress into at least a part of the luminaire based on the sensed functional parameter. Thus, a luminaire system is provided that allows to determine water ingress into a luminaire before the water can damage the luminaire such that the persistence and safety of the luminaire is improved.

1. A luminaire system comprising:
a lighting unit being adapted to provide light,
a housing containing at least a part of the lighting unit, wherein the lighting unit and the housing are parts of a luminaire,
a sensing means positioned at or within the housing adapted to sense a functional parameter indicative of a functional characteristic of the luminaire that is influenced by water ingress into at least a part of an inner structure of the luminaire, wherein the functional characteristic refers to a characteristic of the luminaire that is functionally related to a function of the luminaire; wherein the functional parameter is indicative of a pressure within at least a part of the housing of the luminaire and/or of a temperature of the luminaire; and
a water ingress determination unit being adapted to determine water ingress into at least a part of the inner structure of the luminaire based on the sensed functional parameter; wherein the water ingress determination unit is further adapted to utilize a functional relation between an amount of water and/or water vapor present in the inner structure of the luminaire and the functional parameter.

2. The luminaire system according to claim 1, wherein the water ingress determination unit is adapted to determine the water ingress into at least a part of an inner structure of the luminaire by comparing a sensed functional parameter with a predetermined baseline of this parameter.

3. The luminaire system according to claim 2, wherein the baseline of the functional parameter is predetermined based on a parameter model that is adapted to model the functional parameter of the lighting unit with respect to an ambient environmental condition and/or an operational and/or a water ingress state of the lighting unit.

4. The luminaire system according to claim 1, wherein the sensing means is adapted to sense the functional parameter of the luminaire at different operational states of the lighting unit and wherein the water ingress determination unit is adapted to determine water ingress into at least a part of an inner structure of the luminaire based on a comparison of the functional parameters determined at different operational states of the lighting unit.

5. (canceled)

6. The luminaire system according to claim 1, wherein the sensing means is positioned at the housing of the luminaire and is adapted to sense as functional parameter being indicative of a pressure within at least a part of the housing, of the luminaire a deformation of at least a part of the housing.

7. The luminaire system according to claim 6, wherein the housing comprises at least a flexible part and a rigid part, wherein the flexible part is more flexible than the rigid part, and wherein the sensing means is adapted to sense a deformation of the housing by sensing the deformation of the flexible part of the housing.

8. The luminaire system according to claim 1, wherein the sensing means is adapted to sense as functional parameter being indicative of a pressure within at least a part of the housing of the luminaire a mechanical force applied to at least a part of the housing.

9. (canceled)

10. The luminaire system according to claim 1, wherein the functional parameter being indicative of a temperature of the luminaire refers to a temperature profile measured during a change of the lighting unit from one operational state to another.

11. The luminaire system according to claim 1, wherein a further sensing means is provided that is adapted to sense a humidity parameter indicative of a humidity within at least a part of the housing of the luminaire, wherein the water ingress determination unit is adapted to determine water ingress into at least a part of an inner structure of the luminaire further based on the humidity parameter.

12. The luminaire system according to claim 1, wherein the housing comprises a sinkhole provided such that water present in the housing will accumulate in the sinkhole, wherein a further sensing means is adapted to sense the presence of water in the sinkhole.

13. A luminaire system according to claim 1 further comprising a functional parameter providing unit adapted to provide a functional parameter with respect to another luminaire being part of the luminaire system or being external to the luminaire system, wherein the water ingress determination unit is adapted to receive the provided functional parameter and to determine water ingress into at least a part of the inner structure of the luminaire further based on the provided functional parameter.

14. A method for determining water ingress into at least a part of an inner structure of a luminaire, wherein the method comprises:
providing measurements of a functional parameter of a luminaire comprising a lighting unit and a housing containing at least a part of the lighting unit, wherein the functional parameter is indicative of a functional characteristic of the luminaire that is influenced by water ingress into at least a part of an inner structure of the luminaire, wherein the functional characteristic refers to a characteristic of the luminaire that is functionally related to a function of the luminaire; wherein the functional parameter is indicative of a pressure within at least a part of the housing of the luminaire and/or of a temperature of the luminaire; and
determining water ingress into at least a part of the inner structure of the luminaire based on the sensed functional parameter; wherein the water ingress determination unit is further adapted to utilize a functional relation between an amount of water and/or water vapor present in the inner structure of the luminaire and the functional parameter.

15. A computer program product for determining water ingress into a luminaire, wherein the computer program product comprises program code means causing a computer to execute the method according to claim 14.
